(19) United States
(12) Patent Application Publication
(10) Pub. No.: US 2015/0151721 A1
(43) Pub. Date: Jun. 4, 2015

(54) WINDSCREEN WIPER ACTUATION SYSTEM

(71) Applicant: Caterpillar Inc., Peoria, IL (US)

(72) Inventor: Michael J. Wadzinski, Peoria, IL (US)

(73) Assignee: Caterpillar Inc., Peoria, IL (US)

(21) Appl. No.: 14/096,625

(22) Filed: Dec. 4, 2013

(51) Int. Cl. B60S 1/54

(52) U.S. Cl. CPC B60S 1/546

(57) ABSTRACT

An actuation system for a wiper stick of a vehicle is provided for cleaning the windscreen. The actuation system includes a plurality of nozzles coupled with the wiper stick and configured to eject a pressurized fluid on the windscreen. The actuation system further includes a fluid motor and configured to move the wiper stick on the windscreen. The actuation system also includes a fluid pump to provide the pressurized fluid to the plurality of nozzles and drive the fluid motor. The actuation system may move the wiper stick on the windscreen in a first mode and a second mode. In a first mode, the wiper stick moves on the windscreen due to the ejection of the pressurized fluid from the plurality of nozzles. In a second mode, the fluid motor is operated to move the wiper stick on the windscreen.

### TECHNICAL FIELD

The present disclosure relates to a windscreen wiping system for a vehicle. More specifically, the present disclosure relates to an actuation system for a windscreen wiper of the vehicle.

### BACKGROUND

Construction or mining machines may operate in rigorous conditions. For example, earth moving machines such as an excavator, an off- highway truck or an agricultural vehicle may operate in dusty and unsafe environment. Hence, typical construction or mining machines are provided with a windscreen to protect the operator from external environment. In addition, the windscreen enables the operator to view the external environment. However, the operation of these machines under dusty and/or muddy environments may result in accumulation of dirt/dust/mud on the windscreen. Also, such machines may operate in rainy or foggy conditions that may cause accumulation of mist on the windscreen. These factors reduce the visibility of the external environment through the windscreen. Low visibility may deteriorate the performance of the operator and may lead to accidents on working sites.

Manual cleaning of the windscreen by the operator may increase the downtime of the machine. Also, in certain scenarios, it may be unsafe for the operator to manually clean the windscreen. Therefore, a wiping system is generally used to clean the windscreen. Such wiping system typically may include one or more wiper sticks which may or may not require fluid to clean the windscreen. The wiper sticks are moved on the windscreen by a hydraulic motor or an electric motor. Further, a cleaning fluid may be sprayed on the windscreen by using a fluid pump. However, in certain scenarios, existing actuating and control mechanisms of the wiping system may be complex and costly and unable to adequately clean the windscreen under extremely muddy conditions.

### SUMMARY OF THE DISCLOSURE

The present disclosure is directed to an actuation system of a wiper stick for a windscreen of a vehicle. The wiper stick is configured to move on the windscreen of the vehicle in a first mode and a second mode. The actuation system comprises a plurality of nozzles, a fluid motor, and a fluid pump. The plurality of nozzles is coupled to the wiper stick and is configured to move the wiper stick on the windscreen by ejecting a pressurized fluid in a first mode. Further, the fluid motor is configured to move the wiper stick on the windscreen in a second mode. The fluid pump is configured to provide the pressurized fluid to the plurality of nozzles. Further, the fluid pump is configured to drive the fluid motor.

### BRIEF DESCRIPTION OF DRAWINGS

FIG. 1 illustrates a front view of an exemplary vehicle;

FIG. 2 illustrates a schematic block diagram of an exemplary actuation system for a wiper stick that may be used in conjunction with the vehicle of FIG. 1;

FIG. 3 illustrates a schematic block diagram of the exemplary actuation system for the wiper stick in a first mode of operation; and

FIG. 4 illustrates a schematic block diagram of the exemplary actuation system for the wiper stick in a second mode of operation.

### DETAILED DESCRIPTION OF DRAWINGS

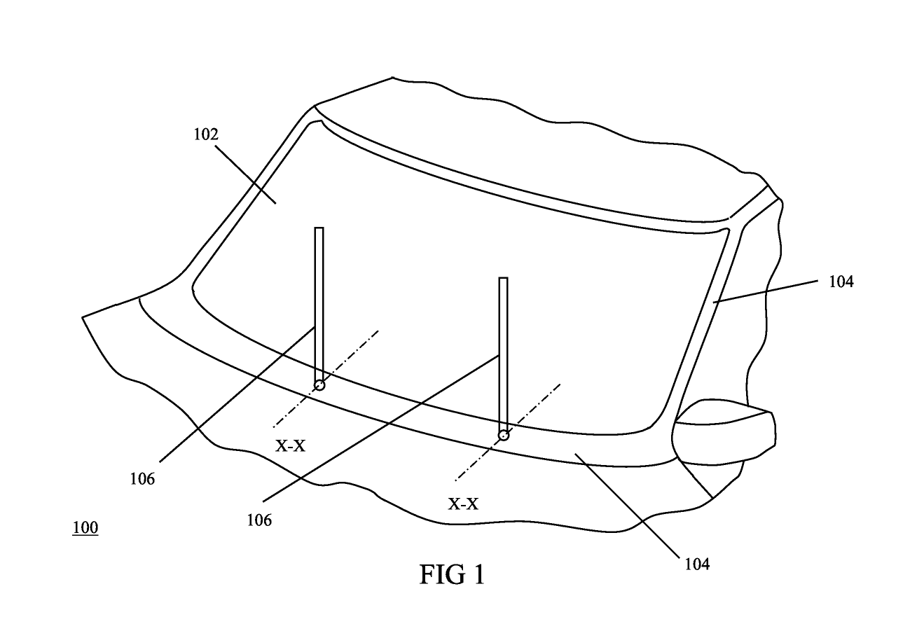

FIG. 1 illustrates a front view of an exemplary vehicle 100 having multiple systems and components that may cooperate to accomplish actuation of a wiper stick. The vehicle 100 may embody a fixed or a mobile machine that performs various operations associated with an industry such as, but not limited to mining, construction, farming, transportation, or automobile industry. For example, the vehicle 100 may be an earth moving machine such as an excavator, a shovel, a backhoe, an automobile or construction machine.

As shown in FIG. 1, the vehicle 100 may comprise a windscreen 102, a frame 104, a wiper stick 106. The windscreen 102 may be mounted on the frame 104 of the vehicle 100. The windscreen 102 may be configured to enable a view of external environment to an operator of the vehicle 100. Also, the windscreen 102 may protect the operator of the vehicle 100 from external dust and other harsh conditions. Dust/dirt/mud on the windscreen 102 may be cleaned by moving the wiper stick 106 on the surface of the windscreen 102. The wiper stick 106 may be mounted on the frame 104 and rotate about an axis X-X. In other words, the wiper stick 106 may rotate about the axis X-X sweeping the windscreen 102. It may be appreciated that the wiper stick 106 may include additional elements, such as but not limited to a wiper blade, known in the art. However, it is understood to a person ordinarily skilled in the art that additional elements nowhere affects the functionality of the present disclosure.

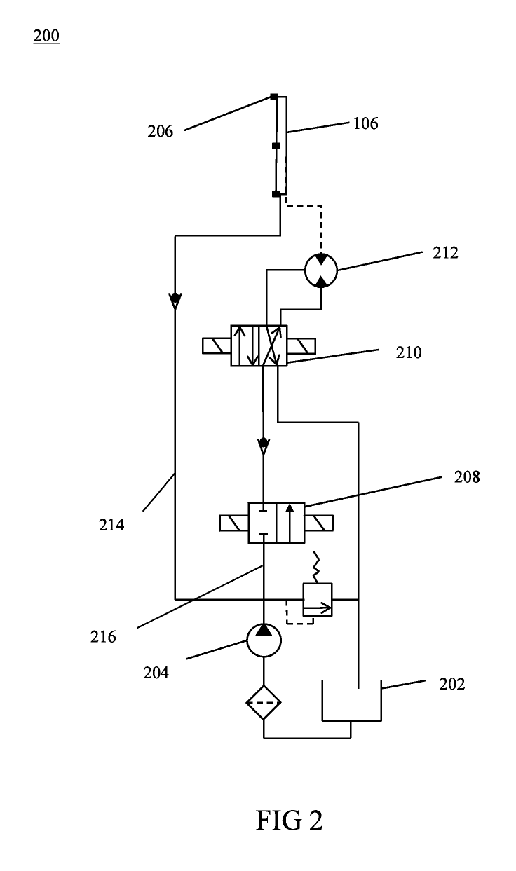

FIG. 2 illustrates an exemplary actuation system 200 that may be used in conjunction with the vehicle 100 of FIG. 1. As shown in FIG. 2, the actuation system 200 may include a reservoir 202, a fluid pump 204, a plurality of nozzles 206, a first control valve 208, a second control valve 210, and a fluid motor 212.

The fluid pump 204 may supply pressurized fluid to the plurality of nozzles 206 or to the fluid motor 212 from the reservoir 202. The fluid pump 204 may supply pressurized fluid to the fluid motor 212 through a line 216 from the reservoir 202. The fluid pump 204 may also supply pressurized fluid to the plurality of nozzles 206 through a line 214 from the reservoir 202.

The plurality of nozzles 206 are configured to spray a pressurized fluid provided by the fluid pump 204 on the windscreen 102. The plurality of nozzles 206 may be coupled with the wiper stick 106. The plurality of nozzles 206 may be coupled with the wiper stick 106 by welding, fastening or any other coupling mechanism known in the art. For example, the plurality of nozzles 206 may be snap fitted on the wiper stick 106. Alternatively, the plurality of nozzles 206 may be small orifices formed in the wiper stick 106. The small orifices may comprise a shape such as a venturi that may increase the velocity of the fluid ejected or sprayed through the plurality of nozzles 206. The wiper stick 106 may move or sweep on the surface of the windscreen 102 in a direction opposite to the direction of the ejection/spray of the pressurized fluid from the plurality of nozzles 206. In other words, the wiper stick 106 may move on the windscreen 102 due the thrust generated by the pressurized fluid ejected/sprayed through the plurality of nozzles 206.

The fluid motor 212 may be configured to move the wiper stick 106 on the surface of the windscreen 102. The fluid motor 212 may be a bidirectional fluid motor and may rotate/move the wiper stick 106 in both clockwise and anticlockwise direction. The fluid motor 212 may be coupled with the wiper stick 106 by linkage a mechanism (not shown) known in the art. The fluid motor 212 is driven by the fluid pump 204. The fluid pump 204 may supply the pressurized fluid from the reservoir 202 through the line 216 via the first control valve 208 and the second control valve 210.

The first control valve 208 may be an ON-OFF valve and may control the flow of the pressurized fluid from the fluid pump 204 to the fluid motor 212. The first control valve 208 may be a 2 port 2 position direction control valve. The first control valve 208 may provide the pressurized fluid to the fluid motor 212 via the second control valve 210. The first control valve 208 may block the flow of the pressurized fluid to the fluid motor 212 when the first control valve 208 is in OFF position.

The second control valve 210 is a direction control valve and controls the direction of flow of the pressurized fluid to the fluid motor 212. The second control valve 210 may be a 4 port 2 positions direction control valve. In one position, the second control valve 210 may direct flow of the pressurized flow to the fluid motor 212 so as to rotate the fluid motor 212 in clockwise direction. In another position, the second control valve 210 may direct the pressurized fluid to the fluid motor 212 so as to rotate the fluid motor 212 in anticlockwise direction.

The first control valve 208 and the second control valve 210 may be an electro-hydraulic valve, an electro-mechanical valve, a hydro-mechanical valve, a hydraulic valve or any other type of valve known in the art. In a certain scenario, the first control valve 208 and the second control valve 210 may be substituted by a single control valve for example 4 port 3 position valve that may function in same manner as the first control valve 208 and the second control valve 210. Further, it may be appreciated that any number of valves can be used to provide the similar functionality.

In an exemplary embodiment, the fluid motor 212 may be a uni-directional motor. In this scenario, the actuation system 200 includes only the first control valve 208. The fluid pump 204 supplies the pressurized fluid from the reservoir 202 through the line 216 via the first control valve 208. The fluid motor 212 may be coupled with a mechanical mechanism (not shown) to move/rotate the wiper stick 106 in both clockwise and anti-clockwise direction. It may be appreciated that any type of the mechanical mechanism can be used to provide the similar functionality.

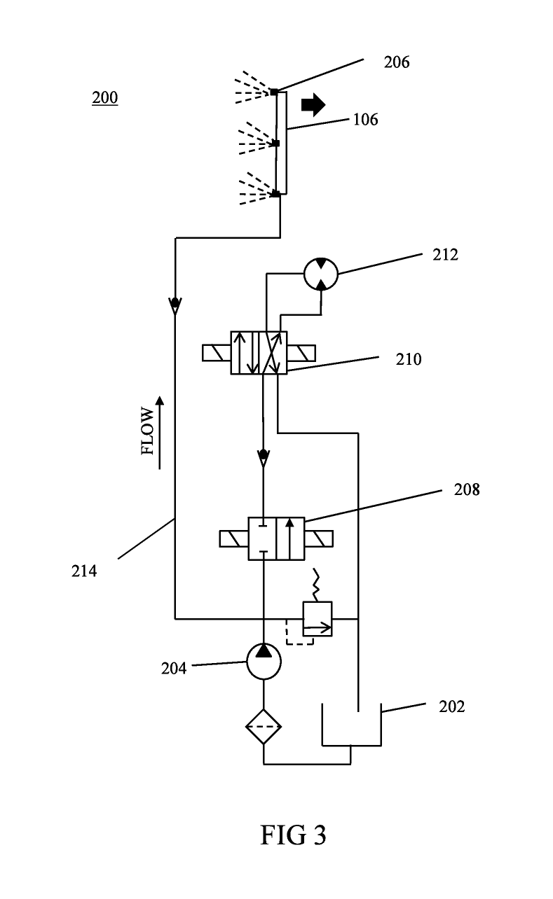

FIG. 3 illustrates the schematic block diagram of the exemplary actuation system 200 in a first mode of operation. The first mode of operation includes ejecting/spraying the pressurized fluid on the surface of the windscreen 102. In the first mode of operation, the first control valve 208 is operated in OFF position (as shown in FIG. 3) to block the flow of the pressurized fluid to the fluid motor 212. However, the fluid pump 204 supplies the pressurized fluid to the plurality of the nozzles 206 through the line 214. The plurality of nozzles 206 may eject/spray the pressurized fluid on the surface of the windscreen 102. The plurality of nozzles 206 ejects/sprays the pressurized fluid at a high velocity in a first direction (as indicated in FIG. 3). The ejection/spraying of the pressurized fluid moves/rotates the wiper stick 106 on the surface of the windscreen 102 in a direction opposite to the first direction. The direction of the movement of the wiper stick 106 is indicated by the arrow in FIG. 3. The wiper stick 106 moves on the windscreen 102 due the thrust generated by the pressurized fluid sprayed/ejected from the plurality of nozzles 206.

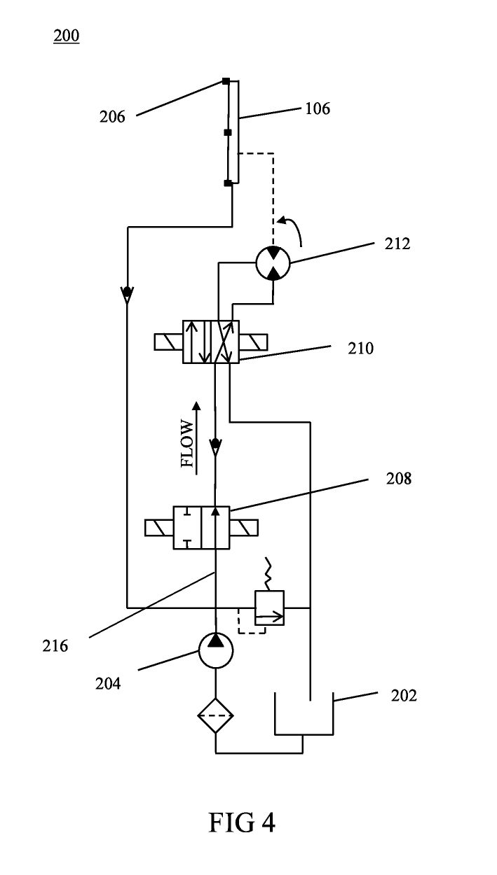

FIG. 4 illustrates the schematic block diagram of the exemplary actuation system 200 in a second mode of operation. The second mode of operation may include moving the wiper stick 106 on the windscreen 102 without spraying the pressurized fluid on the windscreen 102. In the second mode of operation, the first control valve 208 may be operated in ON position to provide the pressurized fluid to the fluid motor 212. The fluid pump 204 may supply pressurized fluid to the fluid motor 212 via the line 216, the first control valve 208 and the second control valve 210. The second control valve 210 switches between two positions to control the direction of the pressurized fluid to rotate the fluid motor 212 in either the clockwise direction or anticlockwise direction. The fluid motor 212 may sweep the wiper stick 106 on the surface of the windscreen 102 in clockwise or anticlockwise direction.

The pressurized fluid is ejected on the windscreen 102 through the plurality of nozzles 206 only when the wiper stick is operated in the first mode of operation. However, it may be appreciated that the pressurized fluid can also be sprayed on the windscreen 102 when the wiper stick 106 is moved in the second mode of operation. It can be contemplated that a suitable supply line and other suitable components may be provided to spray the pressurized fluid on the windscreen 102 while operating in the second mode.

Further, it may be appreciated that the actuation system 200 may include additional components, such as but not limited to a filter, a relief valve, a check valve. However, it is understood to a person ordinarily skilled in the art that additional components nowhere effects or limits the functionality of the present disclosure.

### INDUSTRIAL APPLICABILITY

The vehicle 100 may operate in a dirty/dusty/muddy environment. The operation of the vehicle 100 under dusty environment may result in accumulation of dirt/dust on the windscreen 102. The dirty windscreen may result in low visibility of the external environments for the operator. Therefore, the wiper stick 106 is moved on the windscreen 102 to clean the windscreen 102. A fluid may also be sprayed on the windscreen 102 to remove the dust from the windscreen 102. The wiper stick 106 is moved on the windscreen 102 by the actuation system 200. The actuation system 200 includes the reservoir 202, the fluid pump 204, the plurality of nozzles 206, the first control valve 208, the second control valve 210, and the fluid motor 212.

The actuation system 200 may operate the wiper stick 106 in the first mode or the second mode. When the operator commands the first mode of operation, the pressurized fluid from the fluid pump 204 is sprayed from the plurality of nozzles 206 on the windscreen 102. The wiper stick 106 may move on the surface of the windscreen 102 in a direction opposite to the direction of spray of the pressurized fluid. The wiper stick 106 may move on the surface of the windscreen 102 due to the thrust generated by the ejected pressurized fluid.

When the operator commands the second mode of operation, the fluid pump 204 may drive the fluid motor 212 which in turn moves the wiper stick 106 on the windscreen 102. The fluid motor 212 may move the wiper stick 106 in both clockwise and anti-clockwise direction as commanded by the operator.

The first mode of operation and the second mode of operation may either be activated manually by an operator or automatically based on the inputs from various sensors, such as rain sensor. Further, the first mode of operation and the second mode of operation may be started sequentially in one complete cycle of movement of the wiper stick 106. A controller (not shown in Figure) may be configured to control the operation of the wiper stick 106 in the first mode of operation and/or the second mode of operation. For example, when an operator commands the wiper stick 106 to move on the windscreen 102, a controller (not shown) may trigger the movement of the wiper stick 106 on the windscreen 102 in a first mode. In other words, the wiper stick 106 may sweep the windscreen 102 in a clockwise direction from a first position to a second position by spraying the pressurized fluid from the plurality of nozzles 206 on the windscreen 102. Thereafter, the controller trigger the movement of the wiper stick 106 from the second position to the first position by driving the wiper stick 106 through the fluid motor 212. Therefore, the windscreen 102 of the vehicle 100 is cleaned from the dust.

In a scenario such as during rainy condition, there may not be a need of spraying the pressurized fluid on the windscreen 102. In this scenario, the operator or controller may command the wiper stick 106 to move only in the second mode of operation. Hence, the wiper stick 106 is moved on the windscreen 102 in both clockwise and anticlockwise direction by the fluid motor 212. The direction of movement of the wiper stick 106 is changed by changing the direction of rotation of the fluid motor 212 by controlling the second control valve 210. In one position, the second control valve 210 may direct the flow of pressurized flow to the fluid motor 212 so as to rotate the fluid motor 212 in clockwise direction. In another position, the second control valve 210 may direct the pressurized fluid to the fluid motor 212 so as to rotate the fluid motor 212 in anticlockwise direction. Therefore, the actuation system 200 may move the wiper stick 106 on the windscreen 102 to wipe the windscreen 102.

What is claimed is:

1. An actuation system for a wiper stick for a windscreen of a vehicle, comprising:
a plurality of nozzles coupled to the wiper stick and configured to move the wiper stick on the windscreen by ejecting a pressurized fluid in a first mode;
a fluid motor configured to move the wiper stick on the windscreen in a second mode; and
a fluid pump configured to provide the pressurized fluid to the plurality of nozzles and drive the fluid motor.

2. An actuation system for a wiper stick for a windscreen of a vehicle, comprising:
a plurality of nozzles coupled to the wiper stick and configured to eject a pressurized fluid on the windscreen;
a fluid pump configured to provide a pressurized fluid to the plurality of nozzles;
a fluid motor coupled to the wiper stick, the fluid motor configured to be driven by the fluid pump;
wherein the wiper stick is configured to move on the windscreen by ejecting the pressurized fluid from the plurality of nozzles in a first mode; and
wherein the wiper stick is configured to move on the windscreen by the fluid motor in a second mode.
